(19) United States
(12) Patent Application Publication
(10) Pub. No.: US 2011/0062131 A1
(43) Pub. Date: Mar. 17, 2011

(54) HAND WELDING TORCH

(75) Inventor: Oliver Binzel, Muttenz (CH)

(73) Assignee: TBI INDUSTRIES GMBH, Fernweld-Steinbach (DE)

(21) Appl. No.: 12/880,508

(22) Filed: Sep. 13, 2010

(30) Foreign Application Priority Data
Sep. 11, 2009 (DE) 10 2009 040 907.6
Aug. 27, 2010 (EP) 10174324.3

(51) Int. Cl. B23K 9/00

(52) U.S. Cl. 219/136

(57) ABSTRACT

The invention relates to a hand welding torch (10) provided with a switching device (15), wherein the switching device is formed from a switching element and actuators, wherein the switching element is mounted in such a manner that it can move relatively to the actuators, wherein the actuators can be actuated by means of the switching element, and wherein the switching element can be moved in at least two degrees of freedom.

This application claims priority from German Patent Application No. 10 2009 040 907.6, filed Sep. 11, 2009, and on European Patent Application No. 10174324.3, filed Aug. 27, 2010, the entire disclosure of which are incorporated herein by reference.

### FIELD OF THE INVENTION

The invention relates to a hand welding torch with a switching device, wherein the switching device is formed from a switching element and actuators, wherein the switching element is mounted in such a manner that it can move relatively to the actuators, and wherein the actuators can be actuated by means of the switching element.

### BACKGROUND OF THE INVENTION

Hand welding torches generally have switching devices that are integrated in a handle. The switching devices are essentially used for triggering a welding process with a wire feed for example. Further, further switching devices in the manner of a remote control or a remote control module for controlling welding machine parameters such as wire feed rate, welding power, arc gap, etc. can be integrated in the handle. So, settings of the welding machine can be changed on the handle of the hand welding torch by an operator without the welding process having to be interrupted or the immediate place of work having to be left. The switching devices for setting a welding machine known from the prior art can inter alia be constructed as a double pushbutton, as a double or quadruple rocker switch, as a four-way rocker switch or as a rotary switch with potentiometer. For example, a switching device or remote control can be integrated on an upper side of a handle and additionally an on/off button for actuating the welding function of the welding machine can be integrated on a lower side of the handle.

An operation of the switching device or the remote control on the handle conventionally takes place on the lower side of the handle with the index finger and on the upper side by means of the thumb. It is disadvantageous in the case of the operation of the known switching devices that the operation must take place by means of generally thick welder's gloves, which often has operating errors as a consequence. This is in particular caused in that the known pushbuttons are realised in a relatively small manner due to the limited space conditions on the handle and more than two switching states can be set on a pushbutton. Particularly a use of a plurality of rocker switches is disadvantageous, as here, for a change between the rocker switches, a lifting and changing of the grip of the thumb must take place without an operator being able to direct a glance at the handle during a welding process. This can for example have a simultaneous triggering of two rocker switches of the switching device as a consequence. Also, a stability of the known switching devices is limited, as mechanical loads, such as e.g. impacts directly onto the pushbuttons constructed as actuators bring about.

The present invention is therefore based on the object of suggesting a hand welding torch that possesses an improved operation compared to the hand welding torches known from the prior art.

### SUMMARY OF THE INVENTION

This object is achieved by means of a hand welding torch with the features according to a first embodiment, wherein the hand welding torch (10) is provided with a switching device (15), wherein the switching device is formed from a switching element (21) and actuators (24, 25, 26), wherein the switching element is mounted in such a manner that it can move relatively to the actuators, and wherein the actuators can be actuated by means of the switching element, characterised in that the switching element can be moved in at least two degrees of freedom (44, 45). In accordance with a second embodiment of the invention, the first embodiment is modified so that the switching element (21) can be moved in translational degrees of freedom (44, 45). In accordance with a third embodiment of the present invention, the first embodiment or the second embodiment is further modified so that the switching element (21) can be moved in rotational degrees of freedom.

In accordance with a fourth embodiment of the present invention, the first embodiment, the second embodiment, and the third embodiment are further modified so that the switching device (15) comprises a housing (22), and wherein the switching element is mounted such that it can move relatively to the housing. In accordance with a fifth embodiment of the present invention, the fourth embodiment is further modified so that the housing (22) constructs a slotted guide (42) for the switching element (21). In accordance with a sixth embodiment of the present invention, the fourth and fifth embodiments are further modified so that the switching element (21) has an actuation knob (27) for manual handling. In accordance with a seventh embodiment of the present invention, the sixth embodiment is further modified so that the housing (22) encompasses the actuation knob (27) along its lateral circumference at least to some extent.

In accordance with an eighth embodiment of the present invention, the first embodiment, the second embodiment, the third embodiment, the fourth embodiment, the fifth embodiment, the sixth embodiment, and the seventh embodiment are further modified so that an actuator (24, 25, 26) is constructed as an electromechanical switch. In accordance with a ninth embodiment of the present invention, the first embodiment, the second embodiment, the third embodiment, the fourth embodiment, the fifth embodiment, the sixth embodiment, the seventh embodiment, and the eighth embodiment are further modified so that the actuator (24, 25, 26) is constructed as an optoelectrical switch. In accordance with a tenth embodiment of the present invention, the first embodiment, the second embodiment, the third embodiment, the fourth embodiment, the fifth embodiment, the sixth embodiment, the seventh embodiment, the eighth embodiment, and the ninth embodiment are further modified so that the actuator (24, 25, 26) is constructed as a path measuring element.

In accordance with an eleventh embodiment of the present invention, the first embodiment, the second embodiment, the third embodiment, the fourth embodiment, the fifth embodiment, the sixth embodiment, the seventh embodiment, the eighth embodiment, the ninth embodiment, and the tenth embodiment are further modified so that the switching device (15) has at least four actuators (24, 25, 26). In accordance with a twelfth embodiment of the present invention, the first embodiment, the second embodiment, the third embodiment, the fourth embodiment, the fifth embodiment, the sixth embodiment, the seventh embodiment, the eighth embodiment, the ninth embodiment, the tenth embodiment, and the eleventh embodiment are further modified so that the switching element (21) has a switching ring (30) for the actuation of the actuators (24, 25, 26). In accordance with a thirteenth embodiment of the present invention, the first embodiment, the second embodiment, the third embodiment, the fourth embodiment, the fifth embodiment, the sixth embodiment, the seventh embodiment, the eighth embodiment, the ninth embodiment, the tenth embodiment, the eleventh embodiment, and the twelfth embodiment are further modified so that the switching device (15) has at least one stop (43) for limiting a movement of the switching element (21).

In accordance with a fourteenth embodiment of the present invention, the first embodiment, the second embodiment, the third embodiment, the fourth embodiment, the fifth embodiment, the sixth embodiment, the seventh embodiment, the eighth embodiment, the ninth embodiment, the tenth embodiment, the eleventh embodiment, the twelfth embodiment, and the thirteenth embodiment are further modified so that the switching element (21) is mounted in a movable manner by means of a universal ball joint (28) of the switching element in a mounting assembly (32) of the switching device (15). In accordance with a fifteenth embodiment of the present invention, the first embodiment, the second embodiment, the third embodiment, the fourth embodiment, the fifth embodiment, the sixth embodiment, the seventh embodiment, the eighth embodiment, the ninth embodiment, the tenth embodiment, the eleventh embodiment, the twelfth embodiment, the thirteenth embodiment, and the fourteenth embodiment are further modified so that the mounting assembly (32) has a spring element (33) which can effect a resetting of the switching element (21) into an actuation-free neutral position.

Thus, the hand welding torch according to the invention comprises a switching device, wherein the switching device is formed from a switching element and actuators, wherein the switching element is mounted in such a manner that it can move relatively to the actuators, wherein the actuators can be actuated by means of the switching element, and wherein the switching element can be moved in at least two degrees of freedom.

The invention is based on the idea of providing a switching device on a handle of the hand welding torch, which has a switching element separated from a plurality of actuators. Further, the switching element can be moved in at least two degrees of freedom, so that the actuators can be actuated alone with the one switching element independently of one another. An otherwise error-prone operation of for example a double rocker switch formed from two mutually adjacently arranged switching elements is substantially improved by means of the use of the single switching element in the invention. Also, in the case of the use of only one switching element, a moving of an operating finger or a changing of the grip of a hand is no longer necessary. As a result of the fact that the switching element can be moved in at least two degrees of freedom, the function of a double rocker switch can likewise be fulfilled with the single switching element. Furthermore, it is advantageous that the actuators are separated from the switching element, so that in the case of an external damaging of the switching element, for example by means of the dropping of the hand welding torch, the actuators are not necessarily damaged.

In one non-limiting embodiment, the switching element can be movable in translational degrees of freedom. That is to say a switching procedure can be triggered by means of a pushing or also tipping movement of the switching element along a linear path. In this case, the switching element can be translationally movable in a plurality of directions, for example, along a longitudinal axis of the hand welding torch and transversely to the same.

Alternatively, the switching element can be movable in rotational degrees of freedom. Accordingly, the switching element for carrying out a switching or setting procedure can be rotatable about a longitudinal axis of the switching element. In this case, the switching element can be rotatable by only a few angular degrees or by a plurality of revolutions. It is also conceivable that the switching element, in addition to the rotational movability, can also additionally be moved translationally.

The switching device can be constructed in a particularly easy manner if the same comprises a housing, wherein the switching element can then be mounted such that it can then move relatively to the housing. The switching device can easily be provided with a connection line so that the housing of the switching device can easily be adapted on a handle of the hand welding torch. So, for example, a handle that is present can be provided with a switching device or the housing of the switching device can be inserted in a recess on a handle provided for that. Also, the switching device can then be constructed independently of the hand welding torch, as a result of which the switching device can be produced and exchanged on the hand welding torch in a particularly easy manner.

Also, the housing can construct a slotted guide for the switching element. So, a simultaneous actuation of more than one actuator by means of a guide of the switching element constructed in this manner in the slotted guide can be prevented. In this case, the slotted guide can be constructed in such a manner that a selection of a movement direction of the switching element is enabled only in an actuation-free neutral position of the switching element. The slotted guide can, for example, be constructed as a cross-shaped through opening in the housing, within which the switching element can be moved and in the center of which the neutral position is provided.

In order to facilitate an operation of the hand welding torch or the switching device, the switching element can have an actuation knob for manual handling. The actuation knob can for example be comparatively large with respect to a double rocker switch, so that it can be moved easily with a welder's glove. Particularly, if a rotational movement of the switching element is provided, it is advantageous if the actuation knob is constructed in a round manner.

In order to prevent possible damaging of the actuation knob or of the switching element, the housing can be constructed in such a manner that it encompasses the actuation knob along its lateral circumference at least to some extent. So, it can be ensured that for example, in the case of dropping of the hand welding torch, the hand welding torch does not fall directly onto the actuation knob or an undesired actuation or damaging of the switching element does not take place during an operation of the hand welding torch. In particular, the actuation knob can be sunk into a recess or depression constructed in the housing, so that the actuation knob only slightly protrudes beyond the housing to the extent necessary for an actuation.

In one non-limiting embodiment of the hand welding torch, an actuator can be constructed as an electromechanical switch. The electromechanical switch can, in its simplest form, be a pushbutton or an on/off switch, which can transmit a switching pulse to a welding machine. The electromagnetic switch can, for example, be arranged separately from the switching element and be actuated by this by means of a mechanical contact.

In a further non-limiting embodiment, an actuator can be constructed as an optoelectrical switch. In contrast with an electromechanical switch, in the case of the optoelectrical switch, a switching process can be triggered without a mechanical contact with the switching element. As optoelectrical switches do not possess any mechanically moved components, these switches are particularly long lasting.

Furthermore, an actuator can be constructed as a path measuring element. A path measuring element can, for example, be a linear or rotary potentiometer, a rotary encoder or simply a scale of a sensorialy detectable separation. A path measuring element of this type enables an infinitely variable setting of an operating parameter.

In an advantageous embodiment of the invention, the switching device can have at least four actuators. So, four switching states of the switching device can be realised with only one switching element. The four actuators can be arranged in such a manner that they can be actuated in two movement directions of the switching element. In a simplest embodiment, this can, for example, be a movement of the switching element between a front/back switch position and a left/right switch position. Furthermore, the four actuators can simply be arranged on a printed circuit board. Also, yet further actuators can of course be provided, which can be used in the context of further movement directions.

An actuation of the actuators can then be further simplified in that the switching element has a switching ring. The actuators can then likewise be arranged in the manner of a circle in the region of the switching ring, which can construct a circular contact surface for the actuators. A tipping of the switching ring relatively to the actuators in the direction of one of the actuators then realises its actuation. Due to the use of the switching ring, it is in this case irrelevant how many actuators are arranged in the region of the switching ring.

In order to limit a movement of the switching element, the switching device can have at least one stop. As a result of this, in an advantageous manner it can be prevented that the actuators are, for example, damaged by means of an unintentional impact onto the switching element as a consequence of large force action.

In the event that a housing is provided for the switching device, the housing or a slotted guide of the housing can be constructed in such a manner that the housing constructs the stop for the switching element.

Alternatively, the stop can also be constructed by means of other components that are suitable for limiting a movement of the switching element.

It is particularly advantageous if the switching element is mounted in a movable manner by means of a universal ball joint of the switching element in a mounting assembly of the switching device. The switching element can then be moved as desired in the context of a circular path, which is defined by a sphere surface of the universal ball joint. It also becomes possible to rotate the switching element about its own axis. Compared with a linear guide or a rocker switch, a mounting assembly of this type therefore enables a use of a multiplicity of possible movement directions with a single mounting.

Furthermore, it is advantageous if the mounting assembly has a spring element that can effect a resetting of the switching element into an actuation-free neutral position. That is to say, the switching element can then, after actuation of the switching element by an operator, always be moved back into an initial position automatically. In this case, the neutral position can be chosen in such a manner that no actuators are actuated by the switching element. Also, a spring force of the spring element can be chosen in such a manner or the spring element can be constructed to be settable in such a manner that a desired actuation force of the switching element for switching the actuators must be applied. For example, a hair spring or compression spring can be used as a spring element.

### BRIEF DESCRIPTION OF THE DRAWINGS

A preferred embodiment of the invention is described in more detail in the following with reference to the attached drawings.

In the figures:

FIG. 1: shows a hand welding torch with a switching device in a perspective illustration, in accordance with the present invention;

FIG. 2: shows the hand welding torch with the switching device in an exploded illustration;

FIG. 3: shows the switching device in an enlarged perspective illustration;

FIG. 4: shows a longitudinal sectional view of the switching device;

FIG. 5: shows a perspective illustration of the switching device without a housing;

FIG. 6: shows a perspective illustration of the switching device without an actuation knob.

### DETAILED DESCRIPTION OF THE INVENTION

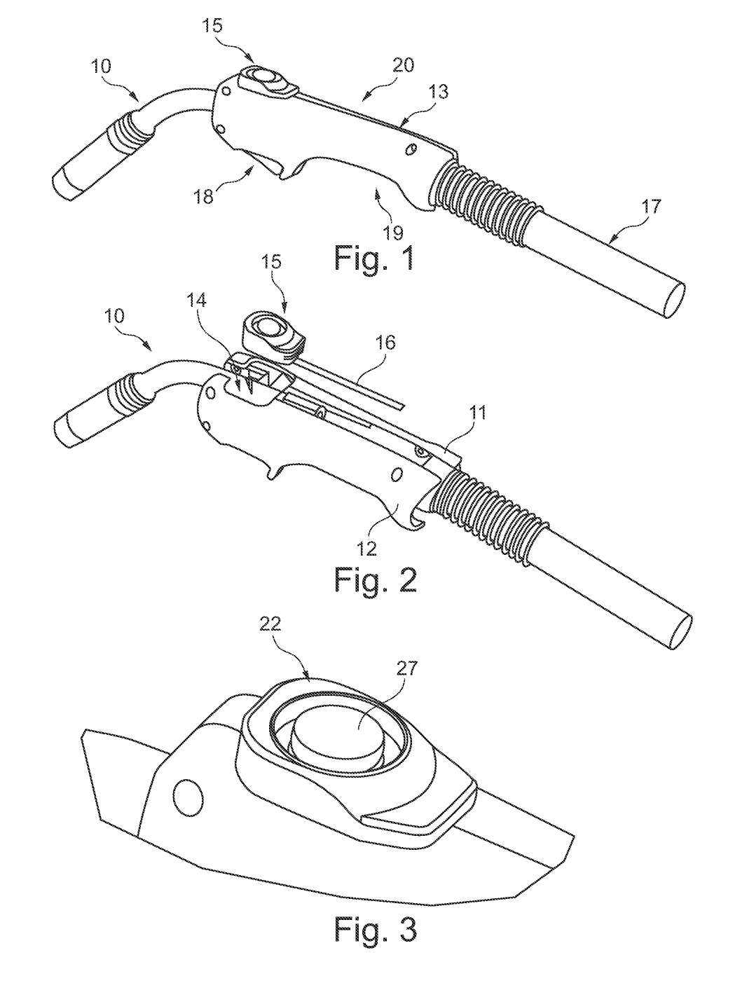

Viewing FIGS. 1 and 2 together shows a hand welding torch 10 of the present invention, provided with a handle 13 formed from grip plates 11 and 12, and a switching device 15 arranged in a recess 14 formed between the grip plates 11 and 12. The switching device 15 is inserted so far into the recess 14 that a connection line 16 of the switching device 15 runs within the handle 13. The connection line 16 is used for the signal transmission to a control, not shown in any more detail here, of a welding machine, which is likewise not completely shown here. The connection line 16 is in this case guided along a supply hose 17. Furthermore, a switching device, which is used for triggering a welding function and constructed as a toggle switch 18, is arranged on the handle 13. The toggle switch 18 is arranged on a lower side 19 of the handle 13 and is preferably actuated with an index finger and the switching device 15 is arranged on an upper side 20 of the handle 13 and is preferably actuated with a thumb.

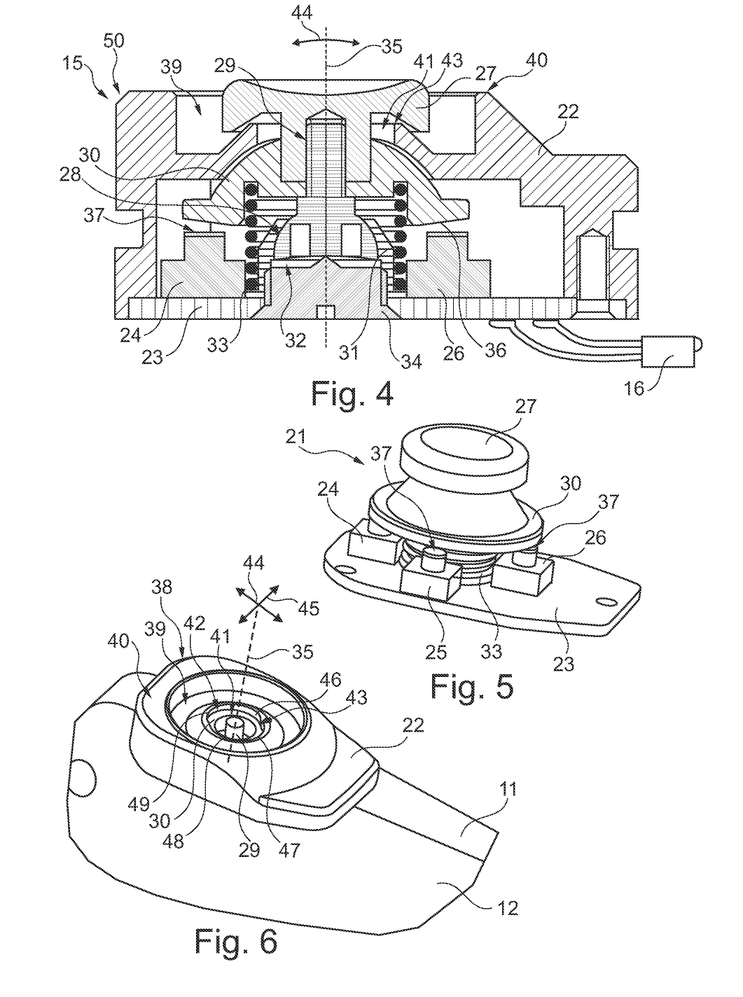

From viewing the FIGS. 3 to 6, the more detailed structure of the switching device 15 can be seen.

The switching device 15 is formed from a switching device 21, a housing 22 and actuators 24, 25, 26 arranged on a printed circuit board 23. A furthermore, fourth actuator is likewise present, yet cannot be seen from the illustrations. The switching element 21 is in turn formed from an actuation knob 27, a universal ball joint 28 with a screw fixation 29 for the actuation knob 27 and a switching ring 30. The universal ball joint 28 lies in a ball socket 31 of a mounting assembly 32 constructed in this manner so that it can move in all directions, wherein a compression spring 33 is arranged between the ball socket 31 and the switching ring 30 and effects a resetting of the switching element 21 into a neutral position shown here. The ball socket 31 is fixed securely by means of a screw 34 on the printed circuit board 23. The mounting assembly 32 constructed in this manner then enables a tipping or a movement of the switching element 21 relatively to a longitudinal axis 35 of the switching element 21. In this case, a contact surface 36 of the switching ring 30 makes it onto a switching contact 37 of one of the actuators 24, 25 or 26 of the actuator, which cannot be seen.

A recess 39, within which the actuation knob 27 is arranged such that it can be moved, is constructed on an upper side 38 of the housing 22. The recess 39 is constructed in such a manner that the actuation knob 27 only protrudes beyond a circumferential edge 40 of the housing 22 slightly and so is protected from damage by means of the circumferential edge 40. Further, a through opening 41 is constructed within the recess 39, which through opening in turn constructs a slotted guide 42 for the actuation knob 27. An inner contour 43 of the through opening 41 is accordingly constructed in such a manner that, in the direction of actuation axes 44 and 45, illustrated here with arrows, material recesses 46, 47, 48 and 49 are provided. As a result, only a movement of the actuation knob 27 or of the switching element 21 in the direction of the actuation axes 44 and 45 starting from the neutral position defined by means of the longitudinal axis 35 is enabled. The material recesses 46 to 49 in this case simultaneously form a stop in each case for the actuation knob 27 or the switch element 21.

Furthermore, the housing 22 is constructed in such a manner that the housing 22 can be closed with the printed circuit board 23, or the through opening 41 can be completely covered by means of the actuation knob 27 independently of an actuation of the same, so that the switching device 15 forms an inherently closed subassembly 50, which can be inserted into the handle 13 via the connection line 16, which is contacted on the printed circuit board 23.

1. A hand welding torch provided with a switching device, wherein the switching device comprises:
(a) a switching element; and
(b) a plurality of actuators; wherein the switching element is disposed so that the switching element is moveable relative to the actuators, and wherein the actuators are actuable by the switching element, wherein the switching element is moveable in at least two degrees of freedom.

2. The hand welding torch according to claim 1, wherein the switching element is moveable in translational degrees of freedom.

3. The hand welding torch according to claim 1, wherein the switching element is moveable in rotational degrees of freedom.

4. The hand welding torch according to claim 1, wherein the switching device comprises a housing, and wherein the switching element is mounted so that the switching element is moveable relative to the housing.

5. The hand welding torch according to claim 4, wherein the housing is constructed to provide a slotted guide for the switching element.

6. The hand welding torch according to claim 5, wherein the switching element has an actuation knob for manual handling.

7. The hand welding torch according to claim 6, wherein the housing encompasses the actuation knob along a lateral circumference at least partially.

8. The hand welding torch according to claim 1, wherein a first actuator of the plurality of actuators is constructed as an electromechanical switch.

9. The hand welding torch according to claim 1, wherein a first actuator of the plurality of actuators is constructed as an optoelectrical switch.

10. The hand welding torch according to claim 1, wherein a first actuator of a plurality of actuators is constructed as a path measuring element.

11. The hand welding torch according to claim 1, wherein the switching device has at least four actuators.

12. The hand welding torch according to claim 1, wherein the switching element has a switching ring disposed for the actuation of the actuators.

13. The hand welding torch according to claim 1, wherein the switching device has at least one stop for limiting movement of the switching element.

14. The hand welding torch according to claim 1, characterised in that the switching element is mounted on the hand welding torch in a movable manner by a universal ball joint of the switching element in a mounting assembly of the switching device.

15. The hand welding torch according to claim 14, characterised in that the mounting assembly has a spring element that operates to effect a resetting of the switching element into an actuation-free neutral position.

16. The hand welding torch according to claim 2, wherein the switching element is moveable in rotational degrees of freedom.

17. The hand welding torch according to claim 2, wherein the switching device comprises a housing, and wherein the switching element is mounted so that the switching element is moveable relative to the housing.

18. The hand welding torch according to claim 17, wherein the housing is constructed to provide a slotted guide for the switching element.

19. The hand welding torch according to claim 3, wherein the switching device comprises a housing, and wherein the switching element is mounted so that the switching element is moveable relative to the housing.

20. The hand welding torch according to claim 19, wherein the housing is constructed to provide a slotted guide for the switching element.
